(19) United States
(12) Patent Application Publication
(10) Pub. No.: US 2022/0367105 A1
(43) Pub. Date: Nov. 17, 2022

(54) INTEGRATED POWER INDUCTOR WITH BOTTOM ELECTRODE WITHOUT CARRIER AND MANUFACTURING METHOD THEREOF

(71) Applicant: INPAQ TECHNOLOGY CO., LTD., Miaoli County (TW)

(72) Inventors: Cheng-Han YU, Taoyuan City (TW); Yi-Cheng CHEN, Miaoli City (TW)

(21) Appl. No.: 17/316,746

(22) Filed: May 11, 2021

(51) Int. Cl. H01F 27/28; H01F 27/29; H01F 41/06; H01F 41/10; H01F 41/02; H01F 27/255

(52) U.S. Cl. CPC H01F 27/2828; H01F 27/29; H01F 41/06; H01F 41/10; H01F 41/0246; H01F 27/255

(57) ABSTRACT

A integrated power inductor integrated with bottom electrode without carrier, the power inductor is composed of a coil, a tin layer, and a magnetic powder envelope etc, wherein the wire of the coil is directly drawn to the bottom of the magnetic powder envelope without via a carrier as an electrode, thereby effectively reducing the risk of the inductor being opened due to too small or incomplete welding points between the coil and the material sheet, and can greatly improve the characteristics, reliability and manufacturing yield of the inductor,

### BACKGROUND OF THEINVENTION

### Field of the Invention

The present invention relates to a power inductor, in particular, a power inductor integrally formed of a lead wire, a tin layer, and a magnetic powder envelope. It uses a wire of a coil, and does not need through a carrier, and directly leads to the bottom as an electrode of integrated power inductor with carrier bottom electrode without carrier and manufacturing method thereof.

### Description of the Related Art

It is known to public that a power inductor mainly includes a coil and a magnetic powder envelope. As shown in FIG. 1, the coil 10 includes a coil body 11, a first lead wire 12 and a second lead wire 13 extend from the coil body 11. The coil 10 is mainly formed by winding wires with a circular or rectangular cross section in a spiral shape. In order to increase the contact area with circuit components such as circuit boards, the ends of the first and second wires 12 and 13 are connected to the sheets 21, 22 of lead frame 20 by welding.

It is customary to find a power inductor with side electrodes and bottom electrodes. The manufacturing process is as follows:

Step one, as shown in FIG. 2A, the first lead wire 12 and the second lead wire 13 of each coil unit 31, 32, and 33 are respectively spot-welded to the sheets 21 and 22 of the lead frame 20;

Step two, as shown in FIG. 2B, the lead frame 20 including the coil units 31, 32, and 33 is placed in a mold and then with magnetic powder is injected into the mold. After die-casting and demolding operations of the molding equipment, a power inductor 40 having a magnetic powder envelope 50 is formed;

Step three, as shown in FIG. 2C, after the division process, a single power inductor element 40 having a magnetic powder envelope 50 is separated, and two sides of the power inductor element 40 have outwardly extending sheets 21 and 22;

Step four, as shown in FIG. 2D, the sheet protruding from the magnetic powder envelope 50 is bent along the side surface and the bottom surface of the magnetic powder envelope 50 to produce a power inductor having both a side electrode 41 and a bottom electrode 42.

Following the diversification and miniaturization of product demand, the improvement of the space utilization rate of electronic components has become the goal of the industry. Therefore, power inductors with bottom electrodes only are the mainstream of present equipment requirements. In view of the common power inductor with bottom electrode only in order to keep the coil fixed during mold casting after being placed in the mold, and not to be deflected by the magnetic powder, a carrier 60 (as shown in FIG. 3A) is provided, said carrier 60 forms a stems 62 at the upper center of a platform 61, and the stem 62 provides a coil element 34 to be fixed. The platform 61 (as shown in FIG. 3B), or the first lead wire 12 and the second lead wire 13 are extended in the same direction along the surface of the platform 61 and then bent to the bottom of the platform 61 (as shown in FIG. 3C). After the molding process, a magnetic powder envelope 50 (as shown in FIG. 3D) covering the coil 34 is made, and the first and second lead wires 12 and 13 extending to the bottom of the magnetic powder envelope 50 are then bent as the bottom electrode.

Another method of making the said common power inductor is to use a platform carrier 70 without a stem (as shown in FIG. 4A). The first lead wire 12 and the second lead wire 13 of the coil 34 can pass through the platform carrier 70 downward (as shown in FIG. 4B), or the first lead wire 12 and the second lead wire 13 can run along the same direction in parallel the surface of the platform carrier 70 and then bent to the bottom of the platform carrier 70 (as shown in FIG. 4C). After the molding process, a magnetic powder envelope 50 (as shown in FIG. 4D) covering the coil 34 is made, and the first and second lead wires 12 and 13 extending to the bottom of the magnetic powder envelope 50 are bent as the bottom electrode.

However, as shown in FIG. 2A, the above-mentioned conventional power inductors with side electrodes and bottom electrodes, in order to maintain a certain strength in the die-casting process of the sheets 21 and 22, the portion of lead frame 20 adjacent to coil units 31, 32, and 33 are surroundly Provided with reinforcing parts 21A and 22A protruding outwards, so that the sheets 21 and 22 occupy a considerable (about 25%) design space inside the magnetic powder envelope, which greatly reduces the utilization rate of the magnetic powder and the inductance specifications; in addition, based on the consideration of space utilization, it is customary to use spot welding to connect the coil wire and the material sheets. It is easy to increase the risk of reliability because the spot welding contact is too small or the welding is incomplete. Furthermore, after the magnetic powder envelope is molded, the bending of the blank will increase the chance of cracks on the side of the component and increase the variable rate of failure. In addition, it is common practice that power inductors with only bottom electrodes, whether it is a carrier with a stem or a platform without a stem, have relatively complicated manufacturing procedures and high manufacturing costs. The use of carrier also occupy a considerable design space inside the magnetic powder envelope, which greatly reduces the utilization rate of the magnetic powder and the specifications of the inductor.

In view of the above, based on accumulated experiences and technologies in manufacturing related products, the inventor researched to solve the above-mentioned deficiencies, and after continuous research and experimental improvement, finally developed and created the present invention, so as to eliminate deficiencies and defects generated in conventional ones.

### SUMMARY OF THE INVENTION

Therefore, the present invention is objected to provide a integrated power inductor with bottom electrode without carrier and manufacturing method thereof. The power inductor does not use a carrier, and is composed of only three parts: a coil, a tin layer, and a magnetic powder envelope. The wire of the coil is drawn directly to the bottom as the bottom electrode.

According to the present invention of the integrated power inductor with bottom electrode without carrier and manufacturing method thereof. The wire drawn to the bottom as the bottom electrode can be flattened to become a flat conduction plate, which can effectively improve the defect due to the solder connection between coil and the material sheet. The lack of a solder connection winding the reliability of the inductor, the shortens the manufacturing process and the manufacturing yield are greatly improved, this is a secondary objective of the present invention.

According to the present invention, of integrated power inductor with bottom electrode without carrier and manufacturing method thereof, by directly leading the coil wire to the bottom as an electrode, the reliability of the inductor and the manufacturing yield can be greatly improved. This is another object of the invention.

According to the present invention of integrated power inductor with bottom electrode without carrier and manufacturing method thereof, the lead wires drawn to the bottom can be processed without flattening, and a flat piece of sheet can be welded as a bottom electrode through a long section. The disadvantages of spot welding connection between the coil and the sheet can be avoided, this is a further object of the present invention.

According to the present invention of integrated power inductor with bottom electrode without carrier and manufacturing method thereof, it is mainly applied to power management systems such as automotive electronics, central processing unit (CPU), graphics processor (GPU), and servers etc for the necessary requirements of passive and to meet customers' requirements for conversion efficiency and product miniaturization with novel process technology, this is a further object of the present invention.

The objective, shape, structure, characteristics, and efficacy of the present invention will become more apparent by describing in detail the embodiments thereof with reference to the attached drawings of which:

### BRIEF DESCRIPTION OF THE DRAWINGS

FIG. 1 is a perspective view of the connection between the common spiral coil and lead frame.

FIGS. 2A to 2D are schematic diagrams of the finished product using the various manufacturing steps for forming the common power inductor with side electrodes and bottom electrodes.

FIGS. 3A to 3D are schematic diagrams of the finished products of various manufacturing steps for forming common power inductor with only a bottom electrode by using of a carrier.

FIGS. 4A to 4D are schematic diagrams of the finished products of various manufacturing steps for forming common power inductor with only a bottom electrode by using a platform carrier.

FIG. 5A is a three-dimensional schematic diagram showing a power inductor in which the bottom electrode of the present invention is integrally formed without using a carrier.

FIG. 5B is a side view of FIG. 5A.

FIG. 6 is a flow chart showing the manufacturing steps of the method for manufacturing a integrated power inductor with bottom electrode without carrier of the present invention.

FIG. 7A is a side view of the coil in the coil forming step of the method for manufacturing a integrated power inductor with bottom electrode without carrier of the present invention.

FIG. 7B is a bottom view of FIG. 7A.

FIG. 8A is a side view of the coil in the flattening step of the method for manufacturing a integrated power inductor with bottom electrode without carrier of the present invention.

FIG. 8B is a bottom view of FIG. 8A.

FIG. 9A is a side view of the coil in the step of upper tin layer formation of the method for manufacturing a integrated power inductor with bottom electrode without carrier of the present invention.

FIG. 9B is a bottom view of FIG. 9A.

FIG. 10A is a side view of the coil in the step of bending the lead wires to the bottom of the method for manufacturing a integrated power inductor with bottom electrode without carrier of the present invention.

FIG. 10B is a bottom view of FIG. 10A,

FIG. 11A is a side view of the power inductor in the die-casting step of the method for manufacturing a integrated power inductor with bottom electrode without carrier of the present invention.

FIG. 11B is a bottom view of FIG. 11A.

FIG. 12A is a side view of the power inductor in the insulation coating step of the method for manufacturing a integrated power inductor with bottom electrode without carrier of the present invention.

FIG. 12B is a bottom view of FIG. 12A.

FIG. 13A is a side view of the power inductor in the grinding step of the method for manufacturing a integrated power inductor with bottom electrode without carrier of the present invention.

FIG. 13B is a bottom view of FIG. 13A.

FIG. 14A is another schematic perspective view of another coil in the method for manufacturing a integrated power inductor with bottom electrode without carrier of the present invention,

FIG. 14B is a schematic perspective view of another coil in the method for manufacturing a integrated power inductor with bottom electrode without carrier of the present invention.

FIG. 14C is another side view of the coil in the method for manufacturing a integrated power inductor with bottom electrode without carrier of the present invention.

FIG. 14D is a schematic perspective view of a coil in another flattening step of the method for manufacturing a integrated power inductor with bottom electrode without carrier of the present invention.

FIG. 15 is a relative comparison diagram of the saturation current characteristic curves of the integrated power inductor with bottom electrode without carrier of the present invention and a conventional inductor through experimental tests.

FIG. 16 is a comparative comparison diagram of the conversion efficiency curves of the integrated power inductor with bottom electrode without carrier of the present invention and the conventional inductor through light load experiments.

FIG. 17 is a comparative comparison of the conversion efficiency curves of the integrated power inductor with bottom electrode without carrier of the present invention and the conventional inductor through heavy load experiments.

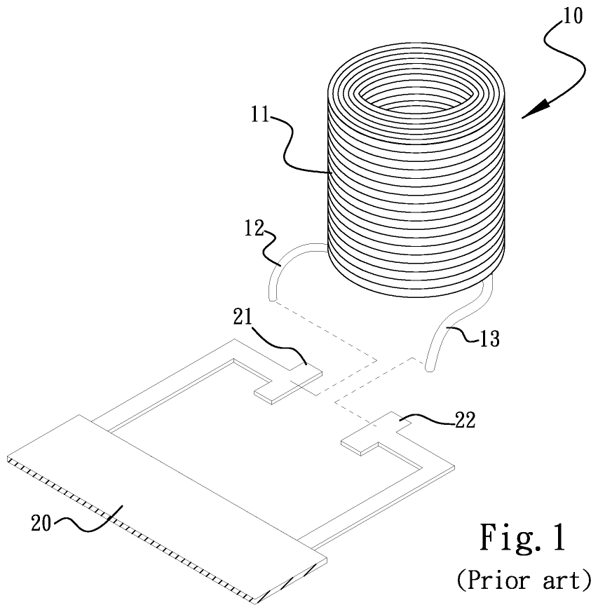

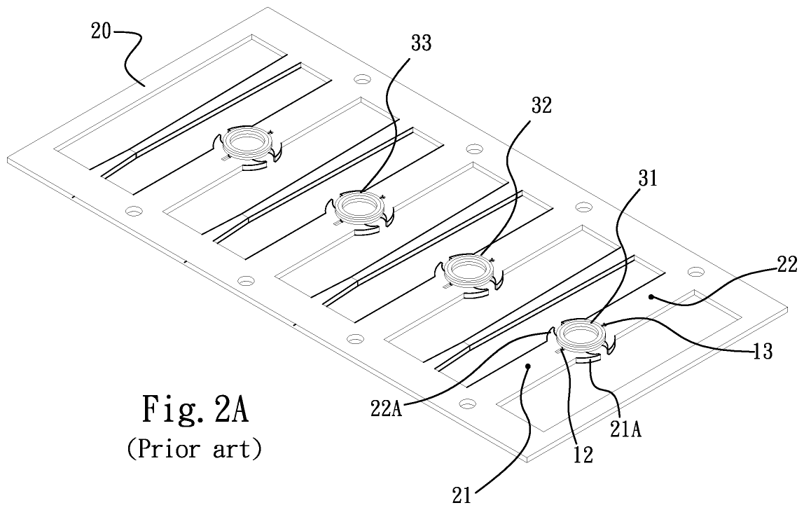

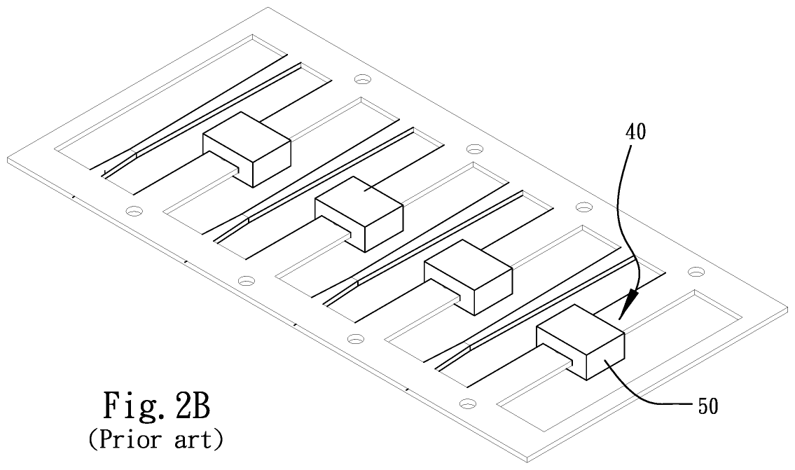

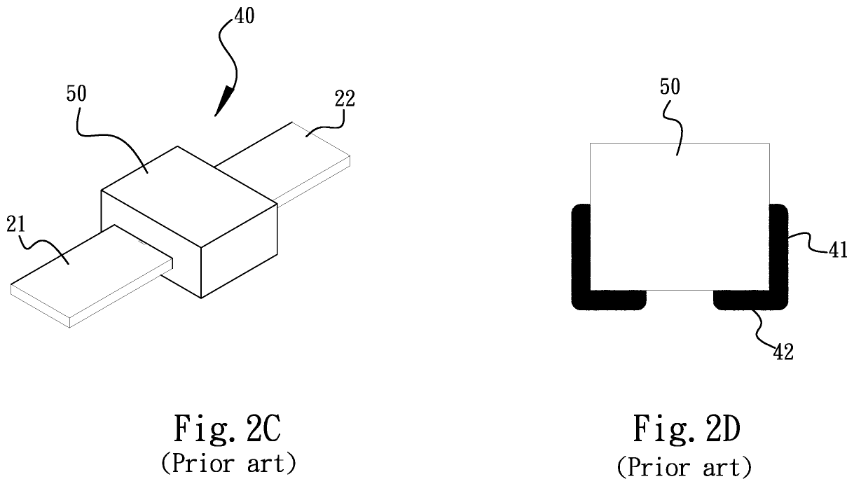

### DETAILLED DESCRIPTION OF' PREFERRED EMBODIMENT

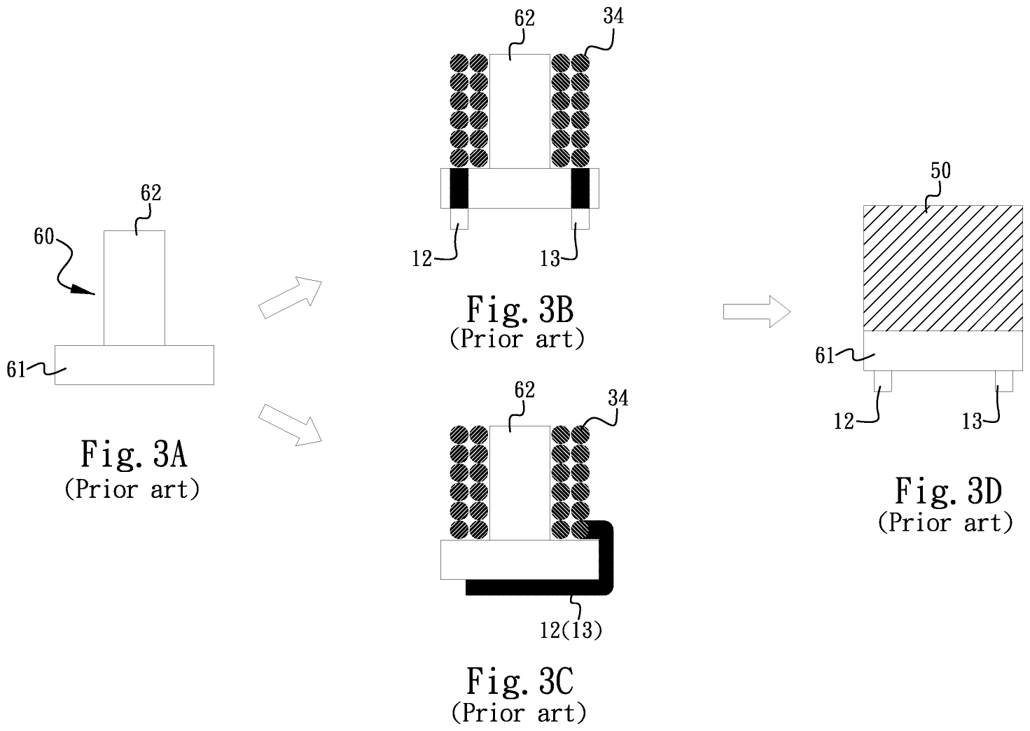

The power inductor of the present invention is integrally formed with a bottom electrode without a carrier. As shown in FIGS. 5A and 5B, the power inductor 200 is composed of a coil 300, a tin layer 400, and a magnetic powder envelope 500. The magnetic powder envelope 500 may be any shape. As shown in the figures, the coil 300 includes a coil body 301 wound in a spiral shape, a first lead wire 302 and a second lead wire 303 extending horizontally from the end of the coil body 301; the end of first lead wire 302 and the second lead wire 303 are formed as flat lead plates 302A and 303A, and the flat lead plates 302A and 303A are covered with a tin layer 400 and bent under the coil body 301. The tin layer 400 at the bottom of the magnetic powder envelope 500 is used as a bottom electrode,

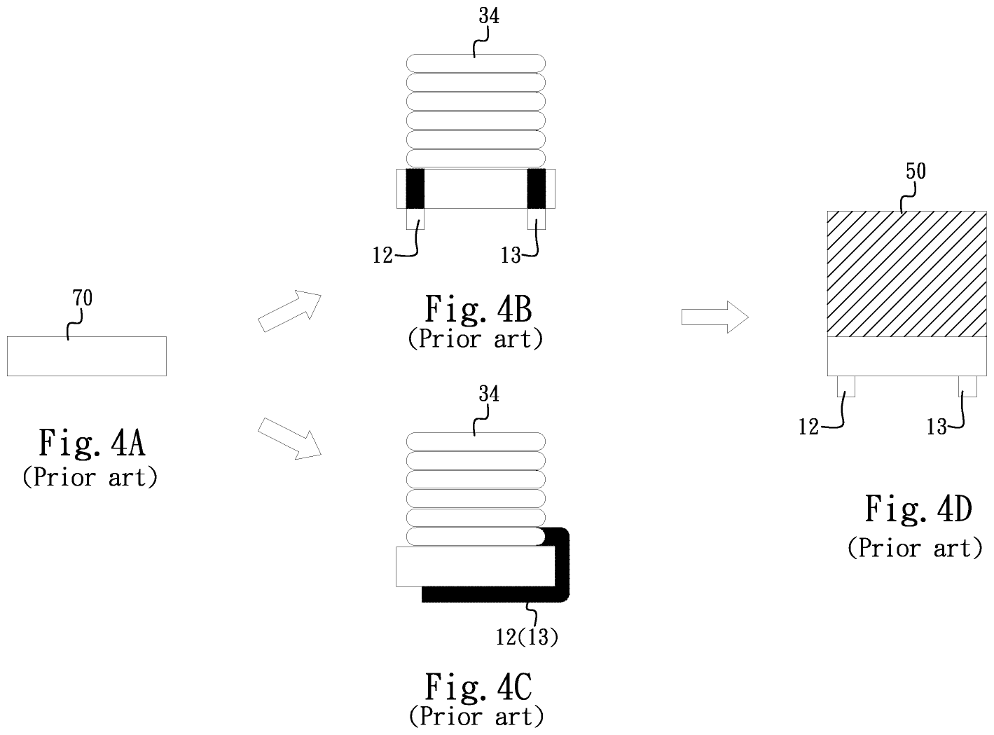

As shown in FIG. 6, the manufacturing process steps of integrally forming a power inductor without a bottom electrode of the present invention include: a coil forming step 200A, a flattening step 200B, a tin layer covering step 200C, a bending step 200D, a die casting step 200E, a insulation coating step 200F, and a grinding step 200G; the above steps are stated as follows.

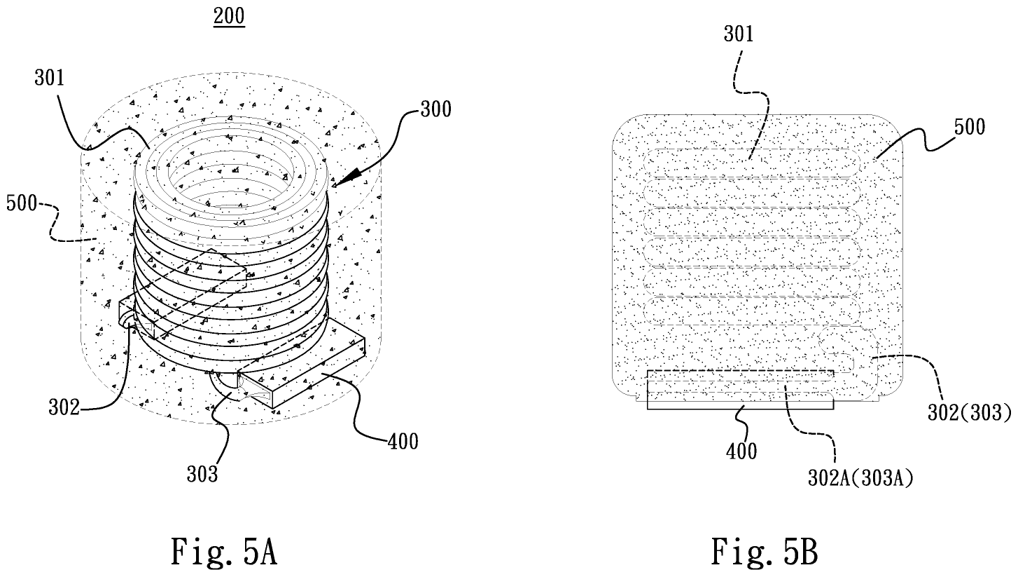

The coil forming step 200A: as shown in FIGS. 7A and 7B, a spiral coil is prepared. The wire of the coil body 301 may be round, flat or other shapes, and copper wires are preferred. The first wire 302 and the second wire 303 of the two end wires of the coil body 301 protrude outward on both sides;

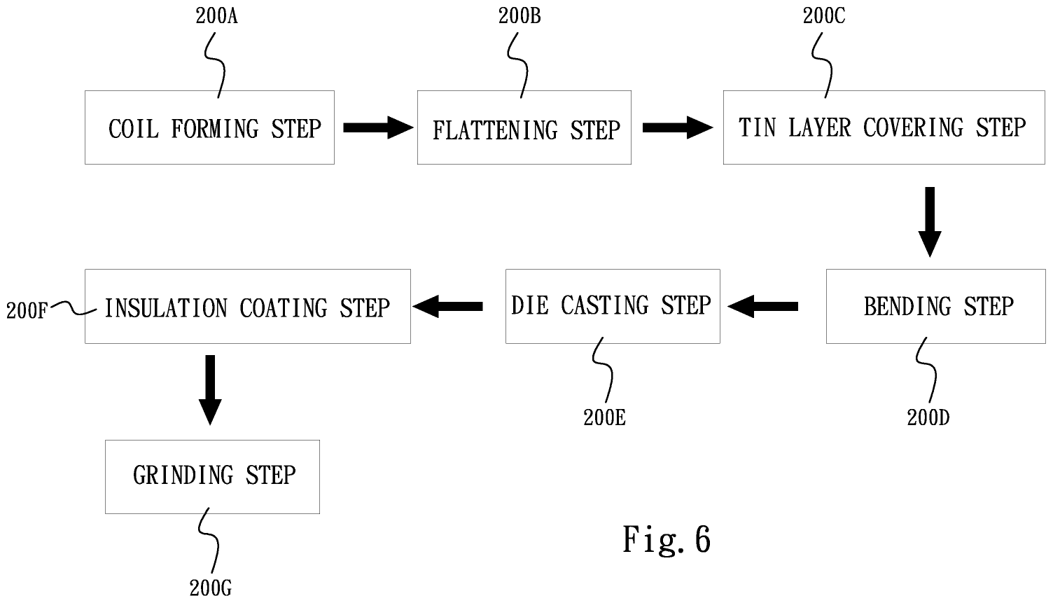

The flattening step 200B: as shown in FIGS. 8A and 8B, the ends of the first lead wire 302 and the second lead wire 303 of the coil body 301 are pressurized to become flat plates 302A and 303A;

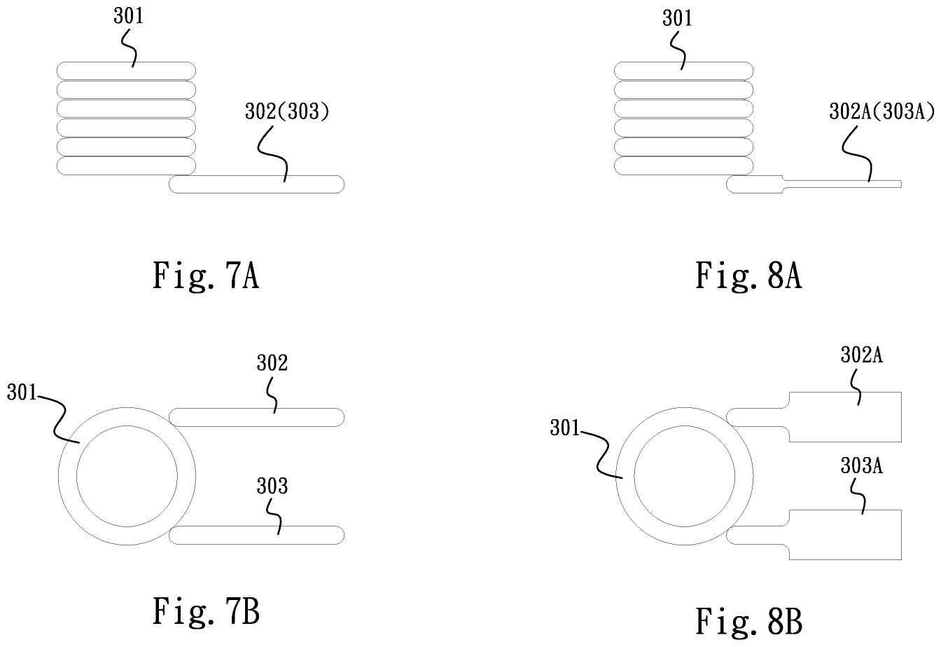

The tin layer covering step 200C: as shown in FIGS. 9A and 9B, a tin layer covering process is performed on the two flat lead plates 302A and 303A, so that each of the flat lead plates 302A and 303A is covered with a tin layer 400;

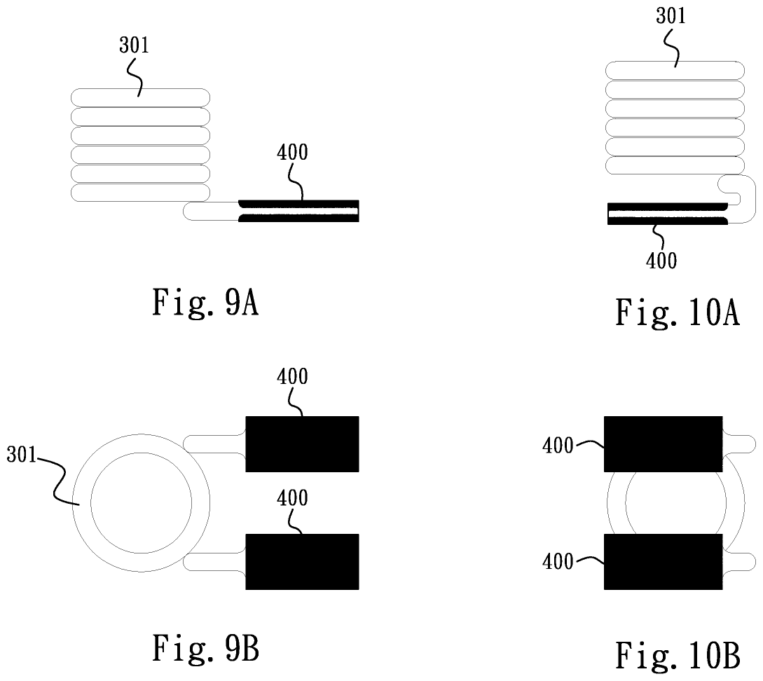

The bending step 200D: as shown in FIGS. 10A and 10B, the flat lead plates 302A and 303A of the outer coating tin layer 400 are bent downward to the lower part of the coil body 301;

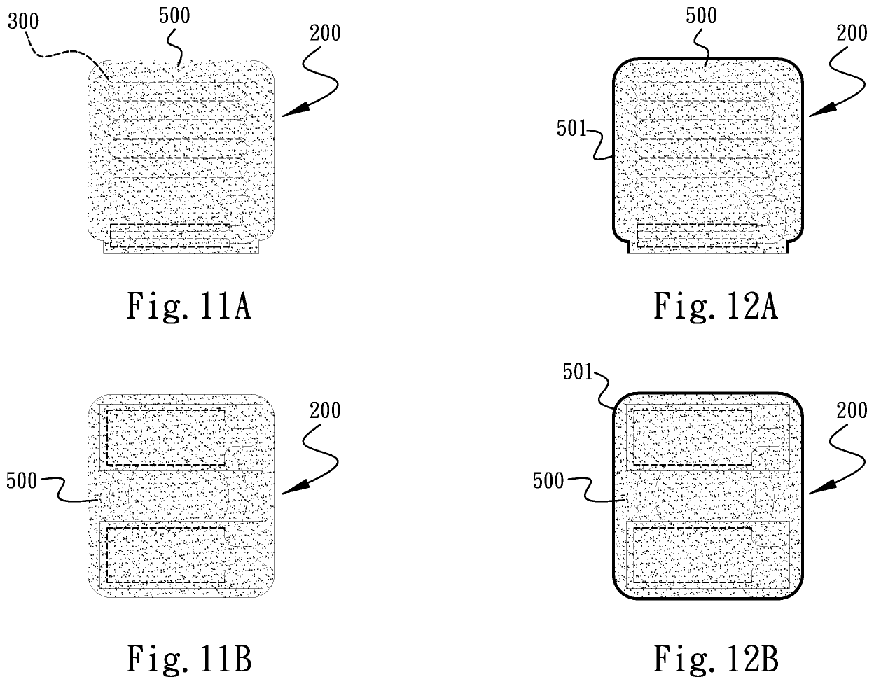

The die casting step 200E: as shown in FIGS. 11A and 11B, the entire spiral coil 300, the flat lead plates 302A and 303A covered with the tin layer 400 are placed into the mould together through the molding process; The coil 300 can be fixed in the mold by the support of the flat lead plates 302A and 303A folded back to the bottom; when the magnetic powder is filled in the mold and then perform the process of die-casting and demolding, such that the power inductor 200 coated with magnetic powder envelope 500 is obtained;

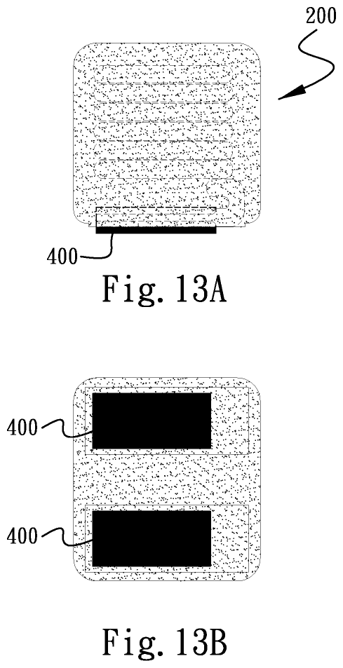

The insulation coating step 200F: as shown in FIGS. 12A and 12B, insulation coating is performed on the outer surface of the magnetic powder envelope 500 to form an insulating layer 501, thereby protecting the magnetic powder envelope 500 from being affected by subsequent processes;

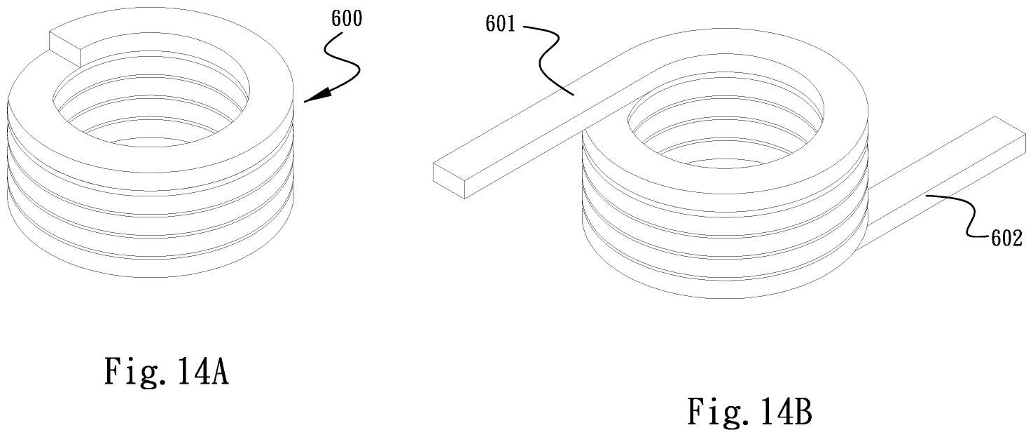

The grinding step 200G: as shown in FIGS. 13A and 13B, the bottom of the magnetic powder envelope 500 is polished to expose the tin layer 400 at the bottom of the flat lead plates 302A and 303A as a bottom electrode to be connected to electrical components such as circuit boards.

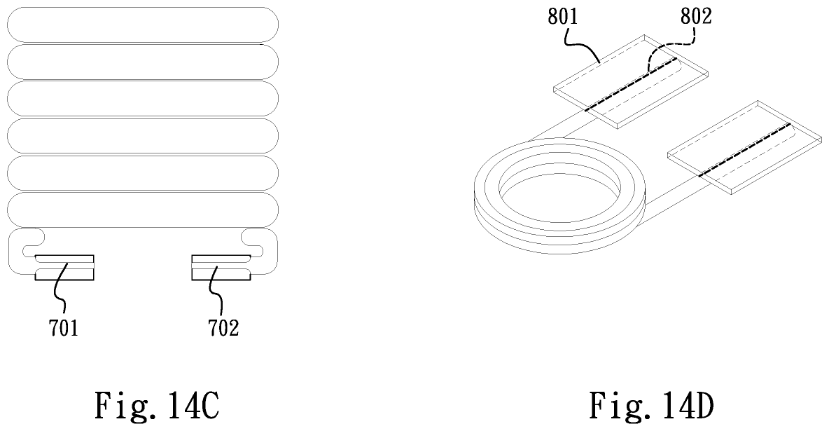

The power inductor of the present invention is integrally formed by the flat lead plates 302A and 303A of the wire coated with a tin layer 400 and exposed at the bottom of the magnetic powder envelope 500 as a bottom electrode, the structure also can be manufactured through the above-mentioned manufacturing process, and can also be adjusted during implementation. For example, as shown in 14A, a flat wire spiral coil 600 wound with a flat wire may be used; or as shown in FIG. 14B, the first lead wire 601 and the second lead wire 602 at both ends of the coil may be respectively extended in opposite directions, or as shown in

FIG. 14C, the flat lead plates 701 and 702 of the wire on both sides of the spiral coil are oppositely bent.

In addition, in the flattening step, the ends of the first lead and the second lead may not be pressed and flattened, but as shown in FIG. 14D, a flat sheet 801 is directly welded to the end of the lead wire, while the length of the wire welding section 802 by the wire end is equivalent to the length of the flat sheet 801. As the welding part is extended, the welding strength is increased, which can avoid the disadvantage of conventional spot welding and does not affect the internal design space of the magnetic powder envelope.

Furthermore, the step 200C of the said tin layer may be omitted, and instead, after the grinding step 200G is completed, a flat lead plate or a flat material sheet as a bottom electrode is exposed under the magnetic powder envelope, and then form the electroplating tin layer.

In addition, the grinding step 200F may be omitted, and the tin layer 400 is directly exposed on the bottom of the magnetic powder envelope 500 as a bottom electrode by directly designing the mold, after completing the die casting step 200E.

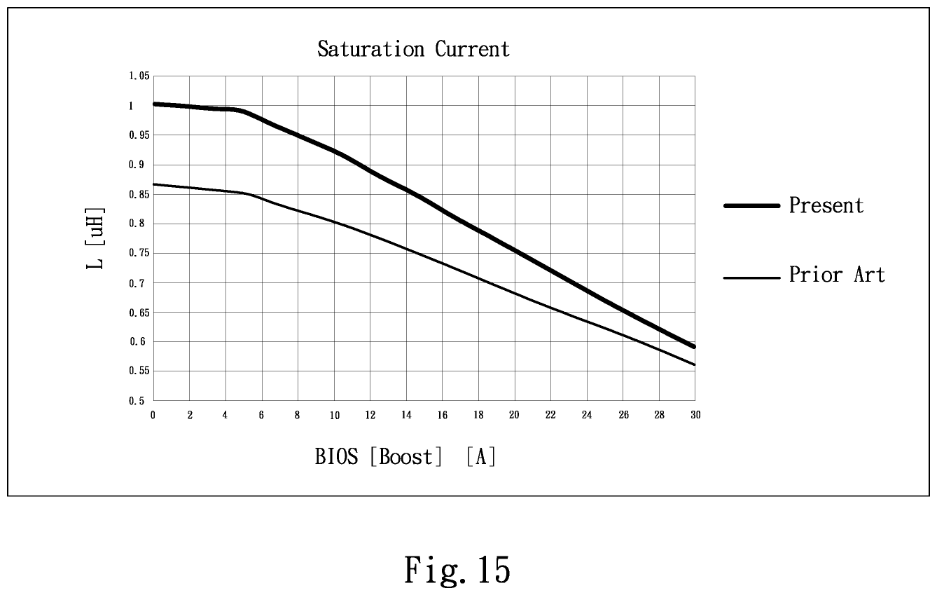

The integrated power inductor with the bottom electrode without carrier of the present invention has been experimentally proved that, as shown in FIG. 15, it is shown that in the products with same specifications, the power inductor of the present invention has a zero bias current (BIAS) of 0˜30 ampere, the saturation current characteristic of the power inductor of the present invention is significantly better than the conventional power inductor. The date of comparison are shown as follows:

| | Inductance | DC resistance [mΩ] | | Saturation current [A] | |
|---|---|---|---|---|---|
| | +/− | | worst | | Best |
| | 20% [μH] | average | value | average | value |
| The | 1 | 5 | 5.2 | 23 | 21 |
| present | | | | | |
| Conventional | 1 | 5.5 | 6.1 | 19 | 16 |
| one | | | | | |

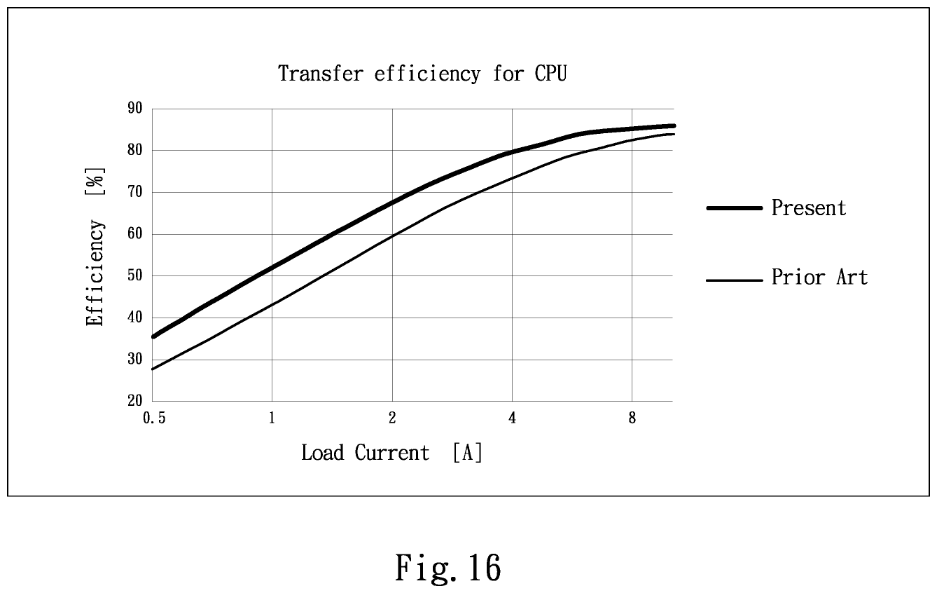

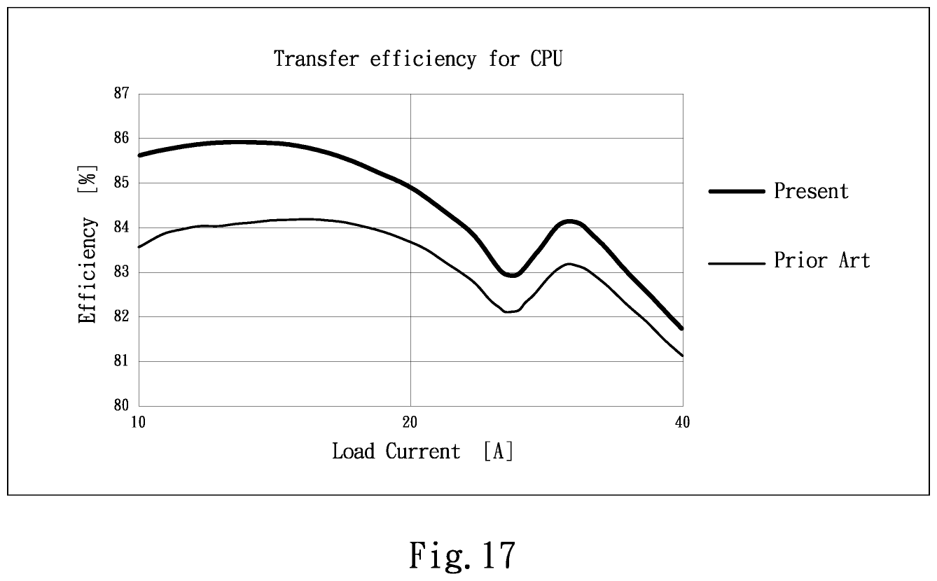

In addition, as shown in FIG. 16 and FIG. 17, whether a light load product with a load current of 0.5 to 8 amperes such as a mobile phone or a high load product with a load. current of 10 to 40 amperes, such as electrical equipment, The conversion efficiency of the power inductor of the present invention to the central processing unit is better than the conventional power inductor.

Therefore, the integrated power inductor with the bottom electrode without carrier manufactured by the above-mentioned manufacturing process has the following characteristics:

1. No carrier is used, so that the magnetic powder envelope can achieve optimal space utilization, and obtain higher magnetic saturation current and lower DC resistance.

2. using the coil wire directly as the bottom electrode can help to reduce the loss of magnetic powder. For the client's power conversion management system, it can provide better conversion efficiency and meet customers' requirements for power specifications

3. it can prevent the risk of short circuit caused by over dense of inductor arrangement, so that the power conversion management system of the client can have more space for use or meet the miniaturization requirements of the client's demands.

4. Different from the conventional power inductor with the spot welding of the wire is used as the electrode. The present invention allows the wire to be directly led out to the bottom as an electrode, which can effectively reduce the risk of incomplete spot welding of the wire and the sheet, causing the risk of open circuits. The reliability of the inductor is greatly improved.

5. The risk of side cracks caused by the material is also reduced.

Based on the above, The integrated power inductor with bottom electrode without carrier and manufacturing method thereof of is not commonly seen in a similar one, which undoubtedly includes a novel and practical features never seen in conventional ones, and then comply the conditions of allowable patents.

What described above are for illustrating the preferred embodiments of the present invention, not for limiting the structure and features of the present invention. Any person skilled in the art shall be able to make modifications and changes to the embodiments without departing from the spirit of the present invention.

What is claimed is:

1. A integrated power inductor integrated with bottom electrode without carrier, the power inductor is composed of a coil, a tin layer, and a magnetic powder envelope; wherein the coil includes a coil body wound in a spiral shape, and a first lead wire and a second lead wire extending from the ends of the coil, the ends of the first lead and the second lead are covered with a tin layer externally, and the coil is covered by the magnetic powder envelope body; characterized in that: a carrier is not provided inside said magnetic powder envelope, and the ends of the first lead wire and the second lead wire of the coil body are exposed from the bottom of the magnetic powder envelope as a bottom electrode.

2. The integrated power inductor integrated with bottom electrode without carrier as claimed in claim 1, wherein the ends of the first lead wire and the second lead wire exposed from the bottom of the magnetic powder envelope are flat lead plate.

3. The integrated power inductor integrated with bottom electrode without carrier as claimed in claim 2, wherein the flat lead plate is covered with a tin layer on the outside.

4. The integrated power inductor integrated with bottom electrode without carrier as claimed in claim 2, wherein the ends of the first lead wire and the second lead wire of the coil body are bent so that the flat lead plate is located below said coil body.

5. The integrated power inductor integrated with bottom electrode without carrier as claimed in claim 2, wherein the flat lead plates of the first lead and the second lead are arranged in parallel and extending in the same direction or opposite direction.

6. A manufacturing method for integrally forming a power inductor with bottom electrode without carrier as claimed in claim 1, the manufacturing steps include: a coil forming step, a flattening step, a bending step, and a die casting step.

7. The method for integrally forming a power inductor with bottom electrode without carrier as claimed claim 6, wherein the coil forming step is to prepare a spiral coil, the coil body of the spiral coil can be round shape, flat shape or other shapes, it is better to use copper wire, and the first and second lead wires protrude from both ends of the coil body.

8. The method for integrally forming a power inductor with bottom electrode without carrier as claimed in claim 7, wherein the flattening step is to press the ends of the first lead and the second lead of the coil body, to make it a flat lead plate.

9. The method for integrally forming a power inductor with bottom electrode without carrier as claimed in claim 8, wherein the step of bending is to fold the first lead and the second lead end so that its flat lead plates are located below the to coil body.

10. The method for integrally forming a power inductor with bottom electrode without carrier as claimed in claim 9, wherein the step of molding is to place said coil body, the first and second lead wire having plate shaped lead plate is placed in a mold, and to fill the magnetic powder in the mold; after die-casting and demolding operations, the entire shape is covered with a magnetic powder envelope, and a partially flat shape-shaped lead plate is exposed as the bottom electrode for power inductor.

11. The method for integrally forming a power inductor with bottom electrode without carrier as claimed in claim 10, wherein before the step of bending, a step of tinning can be added by covering the outside of the flat guide plate with a tin layer to form a flat tin layer.

12. The method for integrally forming a power inductor with bottom electrode without carrier as claimed in claim 10, wherein after the step of molding, the flat lead plate exposed from the bottom of the magnetic powder envelope can be subjected to a tin plating process.

13. The method for integrally forming a power inductor with bottom electrode without carrier as claimed in claim 12, wherein the magnetic powder envelope can be covered with an insulating layer, after the die casting step and before a tin plating process is performed.

14. The method for integrally forming a power inductor with bottom electrode without carrier as claimed in claim 10, wherein if the molding step is completed, while a flat guide plate or a bottom of the magnetic powder envelope is not exposed, a grinding step may be added to expose the flat guide plate or the flat tin layer from the bottom of the magnetic powder envelope as a bottom electrode.

15. The method for integrally forming a power inductor with bottom electrode without carrier as claimed in claim 8, wherein the flattening step may not pressurize the ends of the first and second lead wires of the coil body; instead, a flat material piece is welded to the end of said first lead wire and the end of said second lead wire.
